(19) United States
(12) Patent Application Publication
(10) Pub. No.: US 2012/0043901 A1
(43) Pub. Date: Feb. 23, 2012

(54) LIGHTING DEVICE AND DISPLAYING DEVICE

(75) Inventor: Kohei Nanbu, Osaka (JP)

(73) Assignee: SHARP KABUSHIKI KAISHA, Osaka (JP)

(21) Appl. No.: 13/266,644

(22) PCT Filed: Feb. 17, 2010
(86) PCT No.: PCT/JP2010/052319

§ 371 Date: Nov. 8, 2011

(30) Foreign Application Priority Data
Apr. 28, 2009 (JP) 2009-109387

(51) Int. Cl. H05B 41/36

(52) U.S. Cl. 315/210; 315/209 R

(57) ABSTRACT

In a lighting device (3) including a cold-cathode fluorescent lamp (light source) (9), and a light-emitting surface (10c) that emits light from the cold-cathode fluorescent lamp (9), an inverter circuit (driver circuit) (16) that drives and turns on the cold-cathode fluorescent lamp (9) using PWM dimming; and a lighting control unit (control unit) (15) that receives a dimming instruction signal that gives an instruction on the luminance of the light-emitting surface (10c) input from outside, and conducts driving control of the inverter circuit (16) based on the input dimming instruction signal are disposed. Provided with an LUT (storage unit) (15d) having the relationship between dimming instruction signals and dimming frequencies in PWM dimming stored therein in advance, the lighting control unit (15), when a dimming instruction signal is input, obtains a dimming frequency that corresponds to the input dimming instruction signal from the LUT (15d), and conducts driving control of the inverter circuit (16) such that the cold-cathode fluorescent lamp (9) is driven and turned on by the obtained dimming frequency.

### TECHNICAL FIELD

The present invention relates to a lighting device, and more particularly, to a lighting device using a cold-cathode fluorescent lamp or the like as a light source, and a display device using the lighting device.

### BACKGROUND ART

In recent years, in home television receivers, for example, a display device having a liquid crystal panel as a flat display unit, which has many features, such as being thinner and more lightweight than a conventional cathode-ray tube, has been becoming mainstream as represented by a liquid crystal display device. Such a liquid crystal display device includes a lighting device that emits light (backlight) and a liquid crystal panel that displays a desired image by working as a shutter against light coming from a light source disposed in the lighting device. A television receiver thereby displays information such as characters and images included in the video signal of television broadcasting on a display surface of the liquid crystal panel.

The lighting devices are broadly categorized into a direct lighting type and edge lighting type according to how the light source is placed against a liquid crystal panel. For a liquid crystal display device having a liquid crystal panel of 20 inches or larger, a lighting device of the direct lighting type that can provide high luminance and can be enlarged more easily as compared with the edge lighting type is commonly used. The lighting device of the direct lighting type has a configuration in which a plurality of light sources are placed on the back (non-display surface) side of the liquid crystal panel. Because the light sources can be placed right behind the liquid crystal panel and a large number of light sources can be thereby used, a high luminance can be provided with ease, and therefore, it is suitable for achieving a higher luminance and increasing the device size. Also, because of the hallow structure inside of the device, the lighting device of the direct lighting type remains lightweight even when it is enlarged. For this reason as well, it is suitable for achieving a higher luminance and increasing the device size.

In a conventional lighting device, as described in Patent Document 1 below, for example, adjusting the amount of incoming light from a light-emitting surface to a liquid crystal panel, and controlling the brightness (luminance) of a display surface of a liquid crystal display device by driving and turning on a cold-cathode fluorescent lamp as a light source using PWM (Pulse Width Modulation) dimming have been proposed. That is, this conventional lighting device discloses using PWM dimming having a wider dimming range or a wider adjustable range of the luminance of a light-emitting surface as compared with a conventional current dimming to configure a liquid crystal display device having an improved display property (brightness).

### RELATED ART DOCUMENTS

### Patent Documents

Patent Document 1: Japanese Patent Application Laid-Open Publication No. 2000-292767

### SUMMARY OF THE INVENTION

### Problems to be Solved by the Invention

However, the above-mentioned conventional lighting device has caused a problem of generating sound waves from a cold-cathode fluorescent lamp when the cold-cathode fluorescent lamp (light source) is driven and turned on using PWM dimming, and the generated sound waves is recognized by users as noise.

Specifically, in the conventional lighting device, a cold-cathode fluorescent lamp was driven and turned on by PWM dimming using constant dimming frequency. Therefore, in the conventional lighting device, the electric power supply to the cold-cathode fluorescent lamp was repeated at a regular interval corresponding to a duty cycle in PWM dimming, causing vibration in the cold-cathode fluorescent lamp and a chassis (housing) that contains the lamp. As a result, a problem has been caused in the conventional lighting device that noise having the above-mentioned dimming frequency as the fundamental frequency thereof was generated and recognized by users. Particularly, the conventional direct lighting device as described above generally has a plurality of cold-cathode fluorescent lamps disposed in a housing, and therefore, it was more likely to generate the noise when the respective cold-cathode fluorescent lamps were driven and turned on by PWM dimming.

In view of the above-mentioned problem, it is an object of the present invention to provide a lighting device that can suppress the generation of noise even when a light source is driven and turned on by PWM dimming, and a display device including the lighting device.

### Means for Solving the Problems

To achieve the above-mentioned object, a lighting device according to the present invention includes a light source; a light-emitting surface that emits light from the light source; a driver circuit that drives and turns on the light source using PWM dimming; a control unit that receives a dimming instruction signal that provides an instruction on a luminance of the light-emitting surface input from the outside, and conducts driving control of the driver circuit based on the input dimming instruction signal; and a storage unit storing in advance a relationship between the dimming instruction signals and dimming frequencies in the PWM dimming, wherein when the dimming instruction signal is input, the control unit obtains a dimming frequency that corresponds to the input dimming instruction signal from the storage unit, and conducts driving control of the driver circuit such that the light source is driven and turned on by the obtained dimming frequency.

The lighting device configured in a manner described above has the storage unit storing in advance a relationship between dimming instruction signals and dimming frequencies in PWM dimming. Also, when the dimming instruction signal is input, the control unit obtains a dimming frequency that corresponds to the input dimming instruction signal from the storage unit, and conducts driving control of the driver circuit such that the light source is driven and turned on by the obtained dimming frequency. The generation of noise can be thereby suppressed even when the light source is driven and turned on using PWM dimming, unlike the above-mentioned conventional device.

A lighting device according to the present invention includes a plurality of light sources; a light-emitting surface that emits light from the plurality of light sources; driver circuits that drive and turn on the respective plurality of light sources using PWM dimming; a control unit that receives a dimming instruction signal that provides an instruction on a luminance of the light-emitting surface input from the outside, and conducts driving control of the driver circuits based on the input dimming instruction signal; and a storage unit storing in advance at least one of a relationship between dimming instruction signals and dimming frequencies in the PWM dimming and a relationship between the dimming instruction signals and phase differences for the plurality of light sources, wherein when the dimming instruction signal is input, the control unit obtains, from the storage unit, at least one of a dimming frequency and a phase difference that correspond to the input dimming instruction signal, and conducts driving control of the driver circuit such that the plurality of light sources are driven and turned on by at least one of the obtained dimming frequency and the obtained phase difference.

The lighting device configured in a manner described above has the storage unit storing in advance at least one of the relationship between the dimming instruction signals and the dimming frequencies in PWM dimming and the relationship between the dimming instruction signals and the phase differences for the plurality of light sources. Also, when the dimming instruction signal is input, the control unit obtains, from the storage unit, at least one of the dimming frequency and the phase difference that correspond to the input dimming instruction signal, and conducts driving control of the driver circuit such that the light sources are driven and turned on by at least one of the obtained dimming frequency and the obtained phase difference. The generation of noise can be thereby suppressed even when the light source is driven and turned on using PWM dimming, unlike the above-mentioned conventional device.

In the above-mentioned lighting device, it is preferable that a look-up table be used as the storage unit.

In this case, the instruction process to the driver circuit can be performed faster in the control unit.

Also, in the above-mentioned lighting device, it is preferable that an electric discharge tube be used as the light source.

In this case, a lighting device with high luminance can be configured at a lower cost.

A display device according to the present invention is characterized in using any one of the above-mentioned lighting devices.

In the display device configured in a manner described above, a lighting device that can suppress the generation of noise even when the light source is driven and turned on using PWM dimming is used. Therefore, a display device with less noise and higher performance can be configured with ease.

### Effects of the Invention

According to the present invention, a lighting device that can suppress the generation of noise even when the light source is driven and turned on using PWM dimming, and a display device using the lighting device can be provided.

### BRIEF DESCRIPTION OF THE DRAWINGS

FIG. 1 is a diagram illustrating a lighting device and a liquid crystal display device according to Embodiment 1 of the present invention.

FIG. 2 is a diagram illustrating a configuration of a main section of the lighting device.

FIG. 3 is a diagram illustrating a configuration example of the inverter circuit shown in FIG. 2.

FIG. 4 is a block diagram illustrating a specific configuration of the lighting control unit shown in FIG. 2.

FIG. 5(a) is a waveform diagram showing a specific dimming signal generated in the dimming signal generating unit shown in FIG. 4. FIG. 5(b) is a waveform diagram showing a specific current waveform supplied to a cold-cathode fluorescent lamp from the inverter circuit.

FIG. 6 is an exploded perspective view illustrating a television receiver and a liquid crystal display device using a lighting device according to Embodiment 2 of the present invention.

FIG. 7 is a diagram illustrating a configuration of a main section of the liquid crystal display device shown in FIG. 6.

FIG. 8 is a diagram illustrating a configuration of a main section of the lighting device shown in FIG. 7.

FIG. 9 is a block diagram illustrating a specific configuration of the lighting control unit shown in FIG. 8.

FIG. 10(a) is a waveform diagram illustrating a specific dimming signal generated in the dimming signal generating unit shown in FIG. 9. FIGS. 10(b) and 10(c) are waveform diagrams illustrating specific current waveforms supplied to cold-cathode fluorescent lamps from the inverter circuits.

FIG. 11 is a block diagram illustrating a specific configuration of a lighting control unit of a lighting device according to Embodiment 3 of the present invention.

FIGS. 12(a) and 12(c) are waveform diagrams illustrating specific dimming signals generated in the dimming signal generating unit shown in FIG. 11. FIGS. 12(b) and 12(d) are waveform diagrams illustrating specific current waveforms supplied to cold-cathode fluorescent lamps from the inverter circuits.

### DETAILED DESCRIPTION OF EMBODIMENTS

Hereinafter, preferred embodiments of a lighting device and a display device according to the present invention will be explained with reference to the figures. In the explanations below, cases in which the present invention is used for a transmissive liquid crystal display device are explained as examples. Additionally, the dimension of the components in each drawing is not necessarily true to the dimension, scale ratio of the respective components, or the like of the actual components.

### Embodiment 1

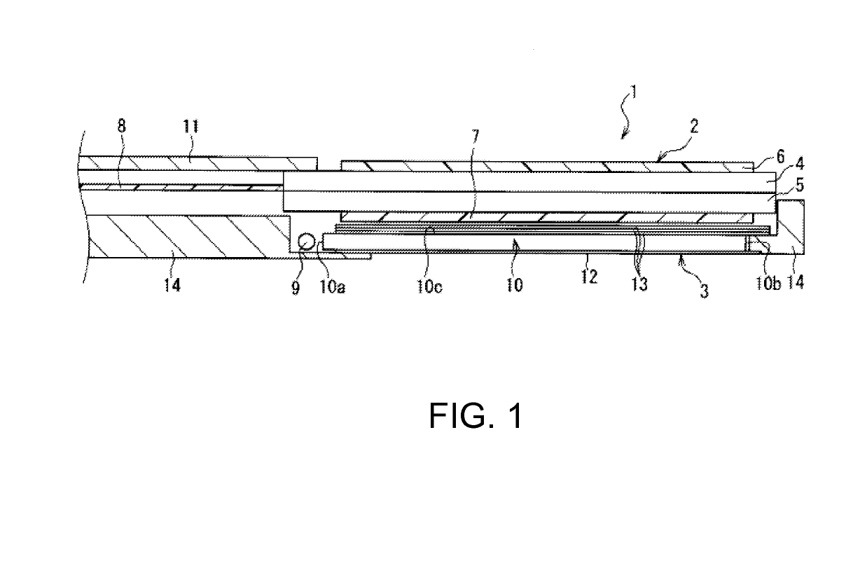

FIG. 1 is a diagram illustrating a lighting device and a liquid crystal display device according to Embodiment 1 of the present invention. In FIG. 1, a liquid crystal display device 1 according to this embodiment has a liquid crystal panel 2 placed so that the top side of FIG. 1 becomes the viewing side (display surface side) thereof, and a lighting device 3 according to the present invention, which is placed on a non-display surface side (bottom side of FIG. 1) of the liquid crystal panel 2, and emits illumination light for illuminating the liquid crystal panel 2.

The liquid crystal panel 2 includes a CF (Color Filter) substrate 4 and an array substrate 5 constituting one pair of substrates, and polarizing plates 6 and 7 that are respectively disposed on the respective outer surfaces of the CF substrate 4 and the array substrate 5. Between the CF substrate 4 and the array substrate 5, a not-shown liquid crystal layer is sandwiched.

The array substrate 5 constitutes one substrate of the above-mentioned one pair of substrates. In the array substrate 5, pixel electrodes, TFTs (This Film Transistors), and the like, corresponding to a plurality of pixels included in the display surface of the liquid crystal panel 2, are formed between the substrate and the liquid crystal layer (not shown). On the other hand, the CF substrate 4 constitutes the other substrate of the above-mentioned one pair of substrates. In the CF substrate 4, a color filter, a common electrode, and the like are formed between the substrate and the liquid crystal layer (not shown).

Also, the liquid crystal panel 2 has an FPC (Flexible Printed Circuit) 8 connected to a control device (not shown) that conducts driving control of the liquid crystal panel 2, and by operating the liquid crystal layer pixel by pixel and driving the display surface pixel by pixel, a desired image is displayed on the display surface.

An edge lighting type device is used for the lighting device 3, and a cold-cathode fluorescent lamp 9 as a light source, and a light guide plate 10 placed opposite to the cold-cathode fluorescent lamp 9 are provided therein. Also, in the lighting device 3, the cold-cathode fluorescent lamp 9 and the light guide plate 10 are sandwiched by bezel 14 that is L-shaped in cross-section, with the liquid crystal panel 2 placed above the light guide plate 10. Also, a case 11 is placed on the CF substrate 4. In this manner, the lighting device 3 is coupled with the liquid crystal panel 2, and integrated as the transmissive liquid crystal display device 1 in which illumination light from the lighting device 3 is incident upon the liquid crystal panel 2.

The light guide plate 10 is made of a synthetic resin such as a transparent acrylic resin, for example, and receives light from the cold-cathode fluorescent lamp 9. Specifically, the light guide plate 10 includes an incident light surface 10a from which light from the cold-cathode fluorescent lamp 9 enters, an opposite surface 10b facing the incident light surface 10a, and a light-emitting surface 10c that emits incident light from the cold-cathode fluorescent lamp 9 to outside. Also, in this embodiment, the light-emitting surface 10c constitutes a light-emitting surface of the lighting device 3, for example.

On the opposite side of the light guide plate 10 to the liquid crystal panel 2 (opposite surface side), a reflective sheet 12 is disposed. Also, on the liquid crystal panel 2 side of the light guide plate 10 (light-emitting surface 10c side), optical sheets 13, such as a lens sheet and a diffusion sheet, are disposed. Therefore, light from the cold-cathode fluorescent lamp 9 guided through the inside of the light guide plate 10 in a prescribed light guiding direction (a direction from the left side to the right side of FIG. 1) is converted to the planar illumination light with uniform luminance, and is provided to the liquid crystal panel 2.

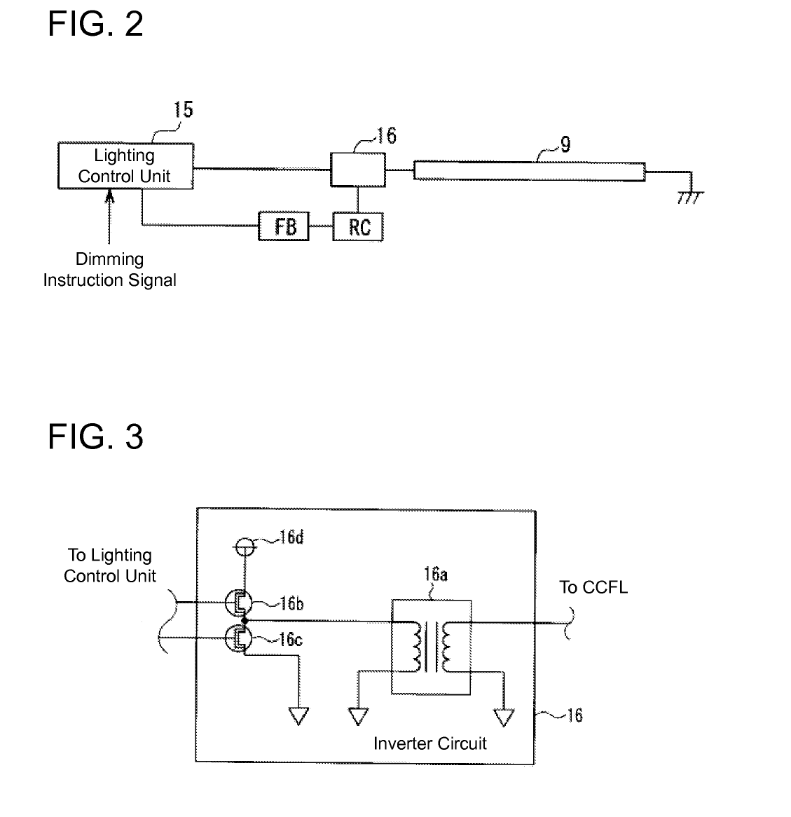

Hereinafter, referring to FIGS. 2 to 4 as well, the lighting device 3 according to this embodiment will be specifically explained.

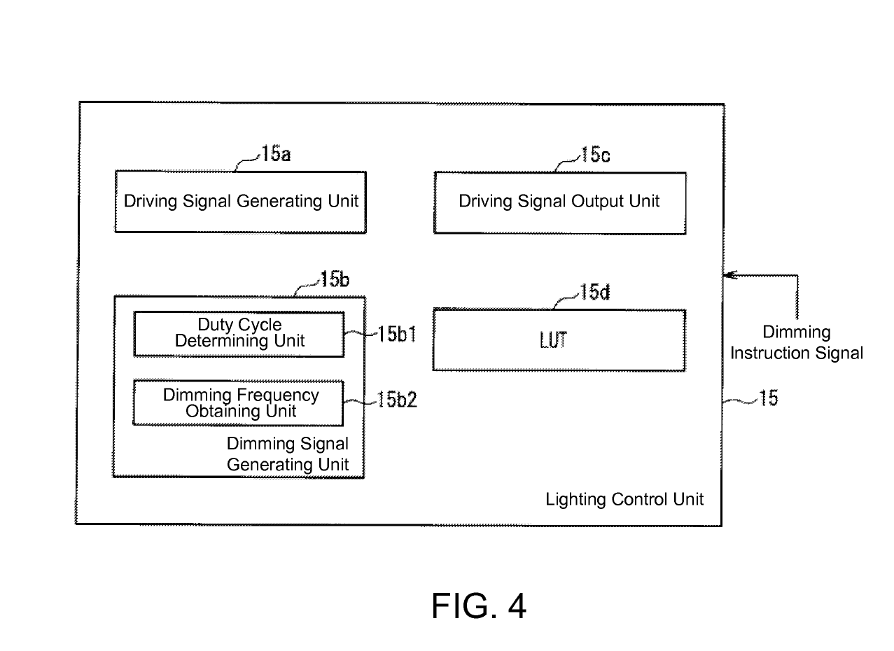

FIG. 2 is a diagram illustrating a configuration of a main section of the lighting device. FIG. 3 is a diagram illustrating a configuration example of the inverter circuit shown in FIG. 2. FIG. 4 is a block diagram illustrating a specific configuration of the lighting control unit shown in FIG. 2.

As shown in FIG. 2, the lighting device 3 has a lighting control unit 15, and an inverter circuit 16, which is a driver circuit that drives and turns on the cold-cathode fluorescent lamp 9 based on a control signal (driving signal) from the lighting control unit 15. The lighting device 3 is configured such that the cold-cathode fluorescent lamp 9 is driven and turned on by the lighting control unit 15 that conducts driving control of the inverter circuit 16 as a control unit.

Also, the inverter circuit 16 is placed in one end side of the cold-cathode fluorescent lamp 9 in the longitudinal direction, and is configured to supply electric current to the cold-cathode fluorescent lamp 9 from the one end side. Additionally, a half-bridge type circuit is used for this inverter circuit 16 as described later, for example, and the inverter circuit 16 is configured to be capable of driving the cold-cathode fluorescent lamp 9 using PWM dimming based on the driving signal.

Further, the lighting device 3 includes a lamp current detection circuit RC that detects a lamp current value running through the cold-cathode fluorescent lamp 9. In the lighting device 3, a lamp current value detected by the lamp current detection circuit RC is output to the lighting control unit 15 through a feedback circuit FB that is disposed for the cold-cathode fluorescent lamp 9.

In the lighting device 3, the specific dimming frequency of the PWM dimming is within a range of about 100 to 500 Hz. As described later, the lighting device 3 according to this embodiment is configured such that the dimming frequency is changed appropriately corresponding to a dimming instruction signal input from the outside. Also, for electric current supplied to the cold-cathode fluorescent lamp 9 (lamp current) during the ON period of PWM dimming, which is specific operating frequency of the cold-cathode fluorescent lamp 9 (driving frequency of the light source), a value in a range of about 30 to 60 KHz is selected as the fundamental frequency during the lighting period.

The lighting control unit 15 receives a dimming instruction signal that provides an instruction on the luminance of the light-emitting surface of the lighting device 3, for example, as an instruction signal from the outside, and the liquid crystal display device 1 is configured such that users can change the luminance (brightness) of the display surface of the liquid crystal panel 2 as desired. That is, the lighting control unit 15 is configured such that a dimming instruction signal is input from an operation input device (not shown), such as a remote controller, disposed on the liquid crystal display device 1 side, for example. The lighting control unit 15 thereby determines a duty cycle in PWM dimming and also determines a target value of electric current supplied to the respective cold-cathode fluorescent lamps 9, using the input dimming instruction signal. Further, as described above, the lighting control unit 15 determines the dimming frequency according to the input dimming instruction signal from the outside.

After that, the lighting control unit 15 generates and outputs a driving signal to the inverter circuit 16 based on the determined target value, thereby changing the lamp current value running through the cold-cathode fluorescent lamp 9. As a result, an amount of outgoing light leaving the cold-cathode fluorescent lamp 9 is changed in accordance with the dimming instruction signal, and thereby the luminance of the light-emitting surface of the lighting device 3 and the luminance of the display surface of the liquid crystal panel 2 are changed appropriately according to the operation instruction from users.

Additionally, the actual lamp current value that has been supplied to the cold-cathode fluorescent lamp 9 is fed back to the lighting control unit 15 as a detected current value through the lamp current detection circuit RC and the feedback circuit FB. Then, the lighting control unit 15 performs a feedback control using the detected current value and the target value of the supply current determined based on the dimming instruction signal so that the display of the user-desired luminance is maintained.

As exemplified in FIG. 3, a half-bridge type circuit that includes a transformer 16a, first and second switching members 16b and 16c that are connected to the lighting control unit 15, and that are disposed in series with each other on the primary winding side of the transformer 16a, and a driving power source 16d connected to the first switching 16b is used for the inverter circuit 16.

The respective first and second switching members 16b and 16c are constituted by field-effect transistors (FETs), for example, and are configured to perform ON/OFF control of a power supply to the cold-cathode fluorescent lamp 9 connected to the secondary winding side of the transformer 16a, by respectively receiving first and second driving signals that are 180-degree out of phase with each other as the above-mentioned driving signals input from the lighting control unit 15.

The inverter circuit 16 performs high-frequency lighting of the cold-cathode fluorescent lamp 9 (FIG. 2). That is, the high-voltage side terminal of the cold-cathode fluorescent lamp 9 is connected to the secondary winding of the transformer 16a. With the first and the second switching members 16b and 16c performing switching operations based on the first and second driving signals from the lighting control unit 15, the transformer 16a supplies electric power to the cold-cathode fluorescent lamp 9, and operates and turns on the cold-cathode fluorescent lamp 9. Also, the lamp current detection circuit RC is connected to the secondary winding of the transformer 16a and the lamp current value in the cold-cathode fluorescent lamp 9 is thereby detected.

Additionally, as shown in FIG. 4, in the lighting control unit 15, a driving signal generating unit 15a, a dimming signal generating unit 15b, a driving signal output unit 15c, and an LUT (look-up table) 15d as a storage unit are provided, and driving signals are generated and output to the inverter circuit 16 connected to the cold-cathode fluorescent lamp 9 based on the above-mentioned dimming instruction signal. Also, in the lighting control unit 15, ICs, LSI circuits, and the like are used for the respective units of the driving signal generating unit 15a, the dimming signal generating unit 15b, and the driving signal output unit 15c, for example. The lighting control unit 15 is configured to turn on the cold-cathode fluorescent lamp 9 with the inverter by determining a duty cycle and dimming frequency in PWM dimming, and generating the driving signals based on a dimming instruction signal from outside.

Specifically, in the lighting control unit 15, the driving signal generating unit 15a, which is for generating driving signals to drive the cold-cathode fluorescent lamp (light source) 9, generates and outputs prescribed driving signals in a range of about 30 to 60 KHz, as described above, to the driving signal output unit 15c. A clock signal generating unit, such as an IC or an LSI circuit, included in the lighting control unit 15 can be used for this driving signal generating unit 15a.

The dimming signal generating unit 15b has a duty cycle determining unit 15b1 and a dimming frequency obtaining unit 15b2 disposed therein. The duty cycle determining unit 15b1 determines a duty cycle of the ON period and the OFF period in the PWM cycle of PWM dimming, with which the cold-cathode fluorescent lamp 9 is driven and turned on, using a dimming instruction signal (instruction signal) from the outside. The dimming frequency obtaining unit 15b2 obtains, from the LUT 15d, a dimming frequency that corresponds to the dimming instruction signal from the outside, and thereby selects the prescribed dimming frequency that corresponds to the dimming instruction signal as instructed at that time. Then, based on the determined duty cycle and the selected dimming frequency, the dimming signal generating unit 15b generates and outputs a dimming signal to the driving signal output unit 15c.

According to the dimming signal from the dimming signal generating unit 15b, the driving signal output unit 15c outputs a driving signal from the driving signal generating unit 15a to the inverter circuit 16 during the ON period of the determined duty cycle.

In the LUT 15d, a relationship between dimming instruction signals and optimum dimming frequencies in PWM dimming has been stored in advance. Specifically, in the LUT 15d, the luminance of the light-emitting surface instructed by a dimming instruction signal and a value of dimming frequency at that luminance, at which a sound wave from the cold-cathode fluorescent lamp 9, or a noise level in the lighting device 3, becomes the lowest are recognized and correlated in advance by conducting a test using an actual product of the lighting device 3, for example. Also, a dimming instruction signal is input into the LUT 15d, and the LUT 15d is connected to the dimming frequency obtaining unit 15b2. In this manner, in the lighting control unit 15, when a dimming instruction signal is input into the LUT 15d, a dimming frequency corresponding to the dimming instruction signal is immediately transmitted to the dimming frequency obtaining unit 15b2, and is reflected in the dimming signal generated in the dimming signal generating unit 15b.

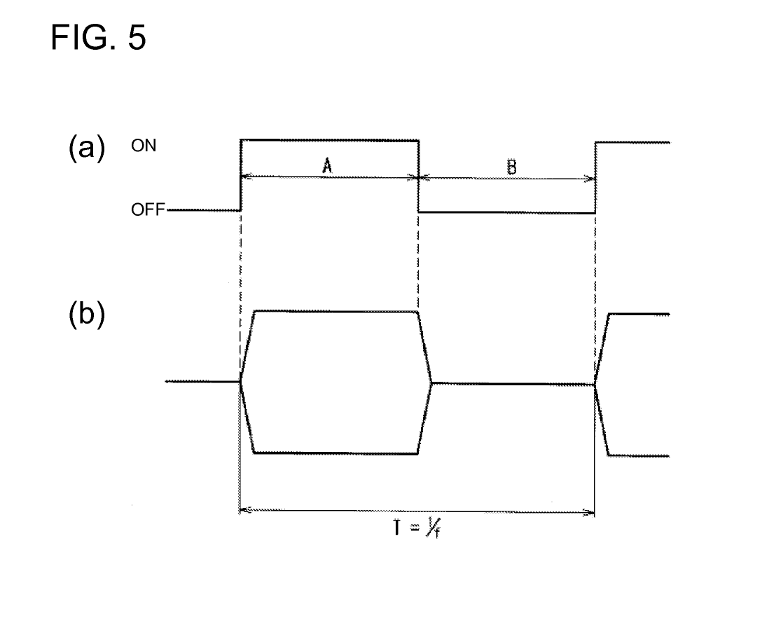

Here, referring to FIG. 5, operations of the liquid crystal display device 1 according to this embodiment configured in a manner described above will be specifically explained. In the explanation below, the lighting operation of the cold-cathode fluorescent lamp 9 of the lighting device 3 is mainly explained.

FIG. 5(a) is a waveform diagram illustrating a specific dimming signal generated in the dimming signal generating unit shown in FIG. 4. FIG. 5(b) is a waveform diagram illustrating a specific current waveform supplied to the cold-cathode fluorescent lamp from the inverter circuit.

In the lighting control unit 15 of the lighting device 3, when a dimming instruction signal is input from the outside, the dimming signal generating unit 15b generates a dimming signal exemplified in FIG. 5(a) based on the input dimming instruction signal. That is, in the dimming signal generating unit 15b, the duty cycle determining unit 15b1 determines ON time A and OFF time B in PWM dimming based on the input dimming instruction signal. Also, the dimming frequency obtaining unit 15b2 obtains a dimming frequency f corresponding to the input dimming instruction signal (i.e. an inverse number of a period T in PWM dimming) from the LUT 15d. Then, the dimming signal generating unit 15b generates and outputs the dimming signal to the driving signal output unit 15c.

After that, the driving signal output unit 15c outputs the driving signal from the driving signal generating unit 15a to the inverter circuit 16 according to the input dimming signal during the above-mentioned ON period A. Electric current is thereby supplied to the cold-cathode fluorescent lamp 9, as shown in FIG. 5(b), and the cold-cathode fluorescent lamp 9 performs the lighting operation.

The lighting device 3 according to this embodiment configured in a manner described above has the LUT (storage unit) 15d in which a relationship between dimming instruction signals and dimming frequencies in PWM dimming is stored in advance. Also, when a dimming instruction signal is input, the lighting control unit (control unit) 15 obtains a dimming frequency that corresponds to the input dimming instruction signal from the LUT 15d, and conducts driving control of the inverter circuit (driver circuit) 16 such that the cold-cathode fluorescent lamp (light source) 9 is driven and turned on by the obtained dimming frequency. In this manner, in the lighting device 3 according to this embodiment, the generation of noise can be suppressed even when the cold-cathode fluorescent lamp 9 is driven and turned on using PWM dimming, unlike the above-mentioned conventional example.

Additionally, in this embodiment, because the lighting device 3 that can suppress the generation of noise even when the cold-cathode fluorescent lamp 9 is driven and turned on using PWM dimming is used, the liquid crystal display device 1 with less noise and higher performance can be configured with ease.

### Embodiment 2

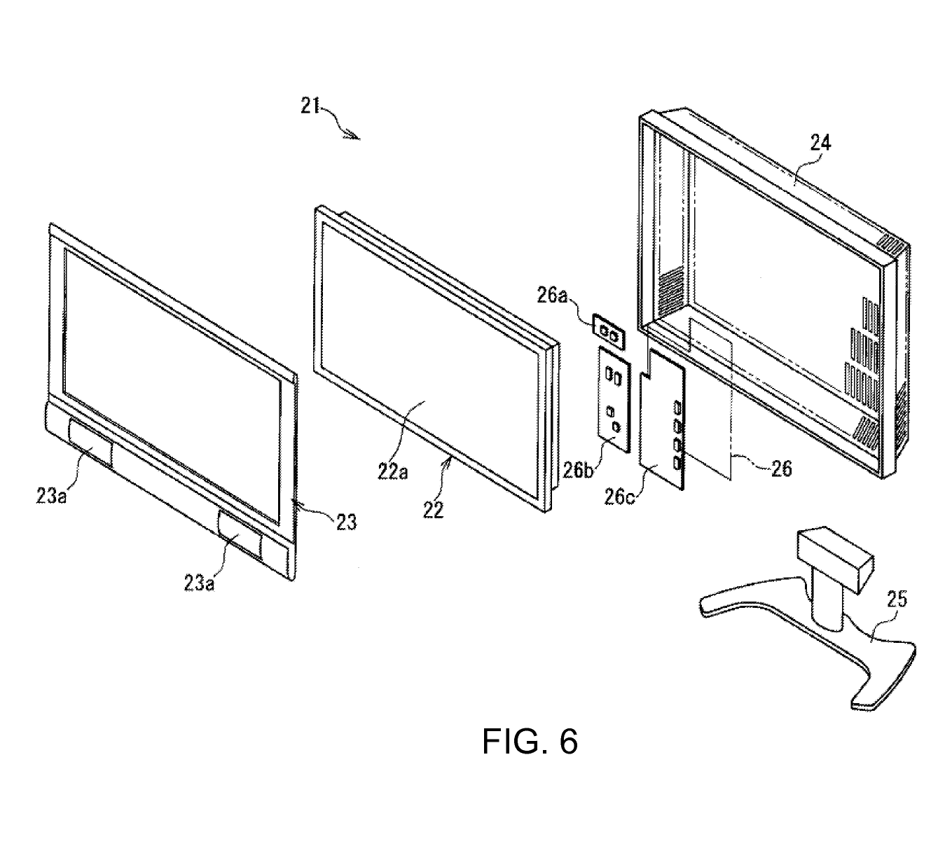

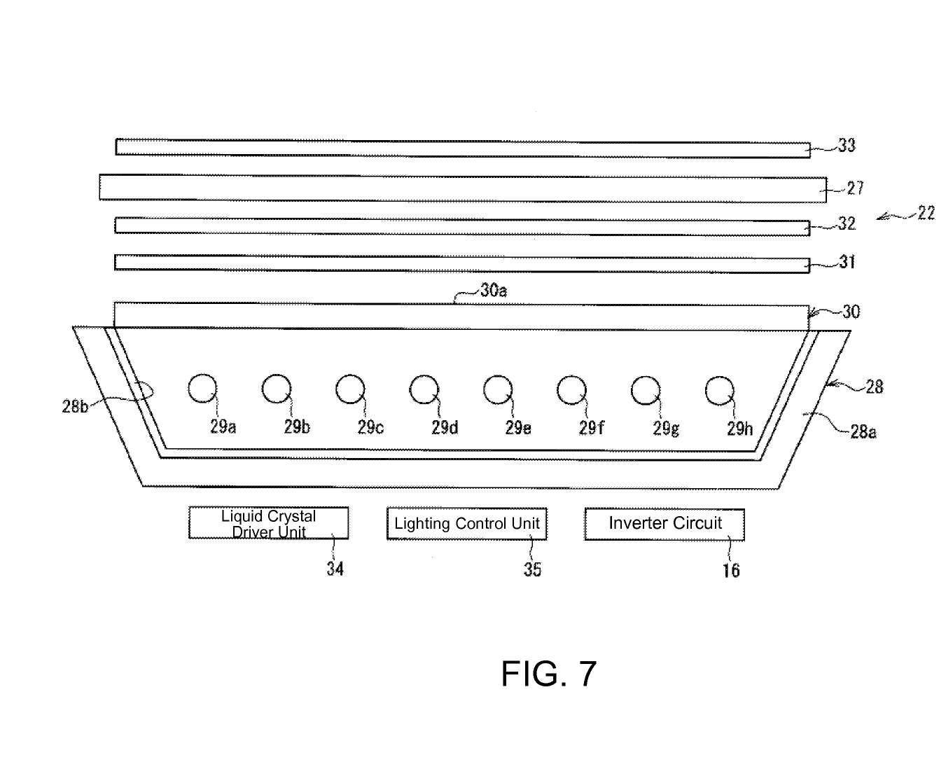

FIG. 6 is an exploded perspective view illustrating a television receiver and a liquid crystal display device using a lighting device according to Embodiment 2 of the present invention. FIG. 7 is a diagram illustrating a configuration of a main section of the liquid crystal display device shown in FIG. 6. In the figures, this embodiment differs from Embodiment 1 above mainly in that a lighting device of the direct lighting type including a plurality of cold-cathode fluorescent lamps is used, and that when a dimming instruction signal is input, a lighting control unit obtains a dimming frequency corresponding to the input dimming instruction signal from an LUT, and conducts driving control of an inverter circuit such that the plurality of cold-cathode fluorescent lamps are driven and turned on by the obtained dimming frequency. The same reference characters are given to the same elements as those in Embodiment 1 above, and the overlapping explanations will be omitted.

That is, in FIG. 6, a television receiver 21 according to this embodiment includes a liquid crystal display device 22 as a display device, and is configured to be capable of receiving television broadcasting by an antenna, a cable, or the like (not shown). The liquid crystal display device 22 is contained in a front cabinet 23 and a back cabinet 24, and is placed vertically by a stand 25. Also, in the television receiver 21, a display surface 22a of the liquid crystal display device 22 is configured to be viewable through the front cabinet 23. This display surface 22a is disposed to be parallel to the direction of action of the gravity (vertical direction) by the stand 25.

Also, in the television receiver 21, a TV tuner circuit substrate 26a, a control circuit substrate 26b controlling each unit of the television receiver 21, such as a lighting device mentioned below, and a power source circuit substrate 26c are attached to a supporting plate 26, and are disposed between the liquid crystal display device 22 and the back cabinet 24. In the television receiver 21, images are displayed on the display surface 22a, and sounds are played and output from speakers 23a disposed in the front cabinet 23 according to video signal of television broadcasting received at a TV tuner on the TV tuner circuit substrate 26a. The back cabinet 24 has many air holes formed therein, and heat generated in a lighting device, a power source, and the like can be thereby released appropriately.

In FIG. 7, the liquid crystal display device 22 includes a liquid crystal panel 27 as a display unit for displaying information such as characters, images, and the like, and a lighting device 28 according to the present invention that is placed on a non-display surface side (bottom side of the figure) of the liquid crystal panel 27, and that generates illumination light for illuminating the liquid crystal panel 27. Such liquid crystal panel 27 and lighting device 28 are integrated as a transmissive liquid crystal display device 22. Additionally, the liquid crystal display device 22 includes a pair of polarizing plates 32 and 33 respectively placed on the non-display surface side and on the display surface side of the liquid crystal panel 27 such that the transmission axes thereof are arranged in the crossed Nicols to each other.

The lighting device 28 is constituted by a direct lighting type device and includes a closed-end chassis 28a as a housing and a plurality (eight, for example) of cold-cathode fluorescent lamps 29a, 29b, 29c, 29d, 29e, 29f, 29g, and 29h (collectively referred to as 29, hereinafter) contained in the chassis 28a, disposed with an equal distance with each other. On the inner surfaces of the chassis 28a, a reflective sheet 28b is disposed, for example, to improve the light use efficiency of the cold-cathode fluorescent lamps 29 by reflecting light from the cold-cathode fluorescent lamps 29 as light sources to the liquid crystal panel 27 side.

Similar to Embodiment 1, straight tube lamps are used for the respective cold-cathode fluorescent lamps 29, and the electrode portions disposed in both ends of the lamps (not shown) are supported outside of the chassis 28a. For the respective cold-cathode fluorescent lamps 29, narrow tube lamps of about 3.0 to 4.0 mm in diameter with an excellent luminous efficacy are used. This makes it possible to configure the lighting device 28 that is compact, and has an excellent luminous efficacy with ease. Also, the respective cold-cathode fluorescent lamps 29 are held inside of the chassis 28a with the respective distances from a diffusion plate 30 and from the reflective sheet 28b maintained at prescribed distances by a not-shown light source holding fixture.

Further, the plurality of cold-cathode fluorescent lamps 29 are arranged such that the longitudinal directions thereof become parallel to the direction perpendicular to the direction of action of the gravity. This can prevent mercury (vapor) sealed inside of the lamps from building up in one end side of the longitudinal direction by the action of the gravity in the cold-cathode fluorescent lamps 29, and therefore, the life of the lamps is greatly improved.

Outside of the chassis 28a, a liquid crystal driving unit 34 that drives the liquid crystal panel 27, a lighting control unit 35 as a control unit of the lighting device 28, and inverter circuits 16 as driver circuits that drive and turn on the respective plurality of cold-cathode fluorescent lamps 29 using driving signals (control signals) from this lighting control unit 35 are disposed. Such liquid crystal driving unit 34, lighting control unit 35, and inverter circuits 16 are disposed on the control circuit substrate 26b (FIG. 1) and placed so as to face the outer side of the chassis 28a.

In the lighting device 28, a diffusion plate 30 disposed so as to cover the opening of the chassis 28a, and an optical sheet 31 placed above the diffusion plate 30 are disposed. The diffusion plate 30 is constituted by using a synthetic resin or a glass material, which is rectangular and about 2 mm thick, for example. Also, in this embodiment, a light-emitting surface 30a of the diffusion plate 30 constitutes a light-emitting surface of the lighting device 28, for example. Additionally, the diffusion plate 30 is held so that it can move on the chassis 28a. Therefore, even if the expansion (plastic) deformation of the diffusion plate 30 is caused by thermal effects such as heat generation of the cold-cathode fluorescent lamps 29 or temperature increase inside of the chassis 28a, the plate can absorb the deformation by moving on the chassis 28a.

The optical sheet 31 includes a diffusion sheet constituted of a synthetic resin film of about 0.2 mm thick, for example, and is configured to improve the display quality in the display surface of the liquid crystal panel 27 by appropriately diffusing the illumination light to the liquid crystal panel 27. Also, on the optical sheet 31, known optical sheet members, such as a prism sheet and a polarizing reflective sheet, for improving the display quality in the display surface of the liquid crystal panel 27 and such, are appropriately laminated as necessary. In this manner, the optical sheet 31 is configured to convert the planar light coming from the diffusion plate 30 to planar light of a prescribed luminance (10000 cd/m², for example) or higher with a substantially uniform luminance, emitting the planar light to the liquid crystal panel 27 side as illumination light.

In addition to the explanations above, an optical member for adjusting the viewing angle of the liquid crystal panel 27, such as a diffusion sheet, may be appropriately laminated above (the display surface side of) the liquid crystal panel 27, for example.

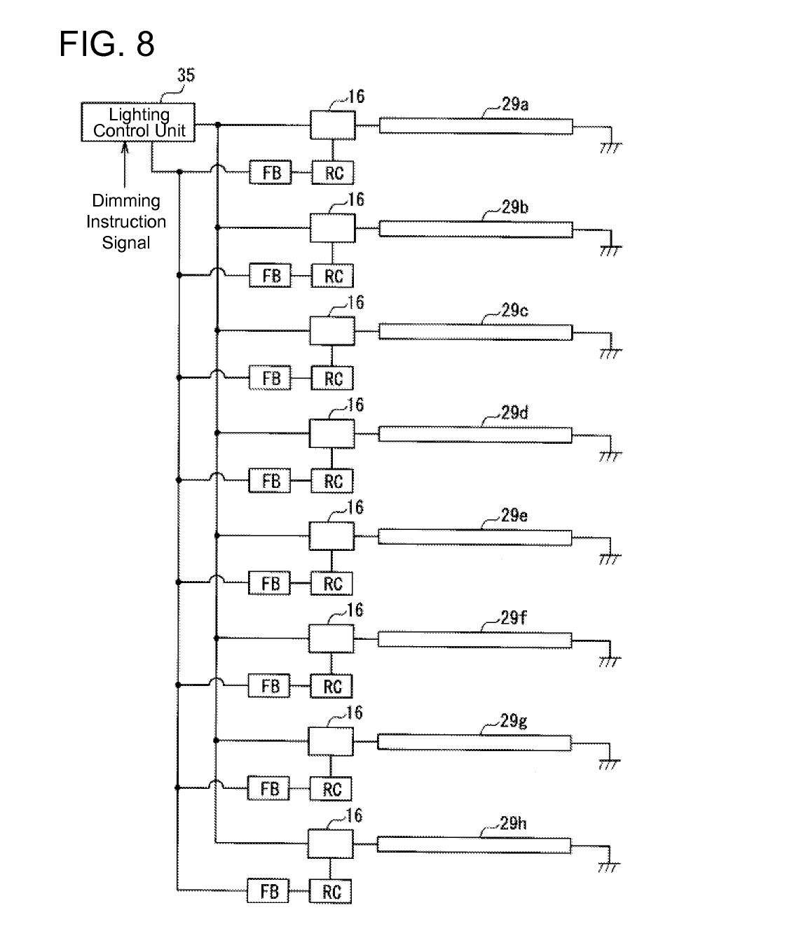

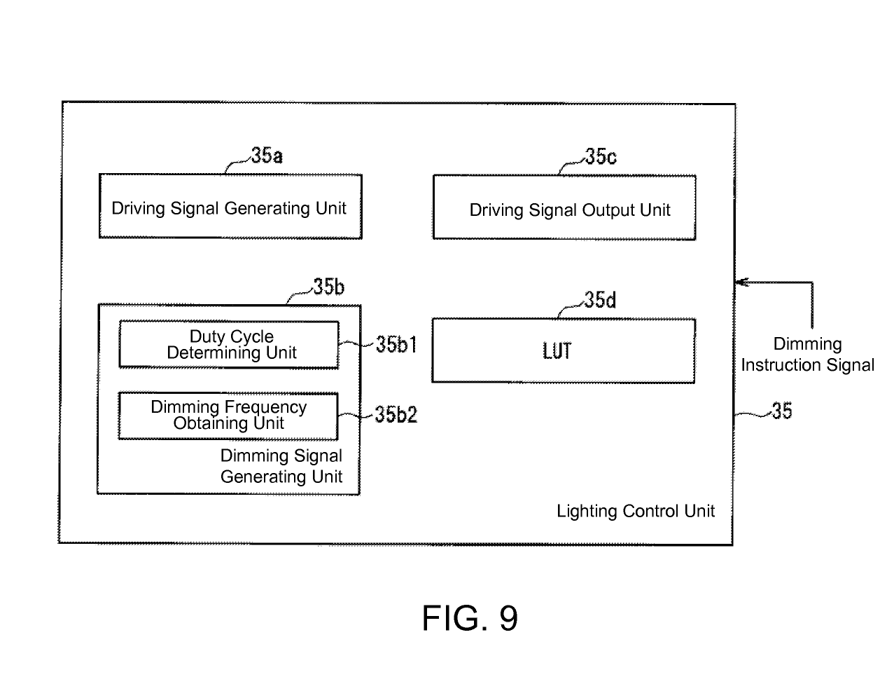

Here, the lighting device 28 according to this embodiment will be specifically explained, referring to FIGS. 8 and 9.

FIG. 8 is a diagram illustrating a configuration of a main section of the lighting device shown in FIG. 7. FIG. 9 is a block diagram illustrating a specific configuration of the lighting control unit shown in FIG. 8.

As shown in FIG. 8, the lighting device 28 includes the above-mentioned lighting control unit 35 for conducting driving control of the respective plurality of cold-cathode fluorescent lamps 29, and the above-mentioned inverter circuit 16 that is disposed for each of the cold-cathode fluorescent lamps 29, and that drives and turns on the corresponding cold-cathode fluorescent lamp 29 based on a control signal (driving signal) from the lighting control unit 35. Similar to Embodiment 1, the inverter circuit 16 is placed in one end side of each of the cold-cathode fluorescent lamps 29 in the longitudinal direction, and is configured to supply electric current to the corresponding cold-cathode fluorescent lamp 29 from the above-mentioned one end side.

Also, similar to Embodiment 1, in the lighting device 28, a lamp current detection circuit RC and a feedback circuit FB are provided for each inverter circuits 16 (each cold-cathode fluorescent lamps 29) so that the lighting control unit 35 drives and turns on the respective cold-cathode fluorescent lamps 29 with the feedback control.

Specifically, the lighting control unit 35 receives a dimming instruction signal that changes the luminance of the light-emitting surface of the lighting device 28, for example, as an instruction signal from the outside. The liquid crystal display device 22 is configured such that users can change the luminance (brightness) of the display surface of the liquid crystal panel 27 as desired. That is, the lighting control unit 35 is configured such that a dimming instruction signal is input from an operation input device (not shown), such as a remote controller, disposed on the liquid crystal display device 22 side, for example. The lighting control unit 35 thereby determines a duty cycle in PWM dimming and also determines a target value of electric current supplied to the respective cold-cathode fluorescent lamps 29, using the input dimming instruction signal. Further, similar to Embodiment 1, the lighting control unit 35 determines a dimming frequency in PWM dimming corresponding to the dimming instruction signal input from the outside.

After that, the lighting control unit 35 generates and outputs driving signals to the respective inverter circuits 16 based on the determined target value, causing the lamp current value running through the corresponding cold-cathode fluorescent lamps 29 to change. As a result, an amount of outgoing light leaving each of the cold-cathode fluorescent lamps 29 is changed according to the dimming instruction signal so that the luminance of the light-emitting surface of the lighting device 28 and the luminance of the display surface of the liquid crystal panel 27 are changed appropriately according to the operation instruction from users.

Additionally, the actual lamp current values that have been supplied to the respective cold-cathode fluorescent lamps 29 are fed back to the lighting control unit 35 as detected current values through the corresponding lamp current detection circuits RC and the corresponding feedback circuits FB. Then, the lighting control unit 35 performs feedback control using the detected current values and the above-mentioned target value of the supply current determined based on the dimming instruction signal so that the display of the user-desired luminance is maintained.

As shown in FIG. 9, the lighting control unit 35 includes a driving signal generating unit 35a, a dimming signal generating unit 35b, a driving signal output unit 35c, and an LUT (look-up table) 35d as a storage unit, and generates and outputs driving signals to the inverter circuits 16 connected to the cold-cathode fluorescent lamps 29 based on the above-mentioned dimming instruction signal. In the lighting control unit 35, ICs, LSI circuits, and the like, for example, are used for the respective units of the driving signal generating unit 35a, the dimming signal generating unit 35b, and the driving signal output unit 35c. The lighting control unit 35 is configured to turn on the respective plurality of cold-cathode fluorescent lamps 29 with inverters by determining a duty cycle and a dimming frequency in PWM dimming, and by generating driving signals based on a dimming instruction signal from the outside.

Specifically, in the lighting control unit 35, the driving signal generating unit 35a, which is for generating driving signals to drive the cold-cathode fluorescent lamps (light sources) 29, generates and outputs prescribed driving signals in a range of about 30 to 60 KHz to the driving signal output unit 35c, similar to Embodiment 1. A clock signal generating unit, such as an IC or an LSI circuit, included in the lighting control unit 35 can be used for this driving signal generating unit 35a.

The dimming signal generating unit 35b has a duty cycle determining unit 35b1 and a dimming frequency obtaining unit 35b2 disposed therein. The duty cycle determining unit 35b1 determines a duty cycle of the ON period and the OFF period in the PWM cycle of PWM dimming, with which the cold-cathode fluorescent lamps 29 are driven and turned on, using a dimming instruction signal (instruction signal) from the outside. The dimming frequency obtaining unit 35b2 obtains, from the LUT 35d, a dimming frequency that corresponds to the dimming instruction signal coming from the outside, and thereby selects a prescribed dimming frequency corresponding to the dimming instruction signal as instructed at that time. Then, based on the determined duty cycle and the selected dimming frequency, the dimming signal generating unit 35b generates and outputs a dimming signal to the driving signal output unit 35c.

According to the dimming signal from the dimming signal generating unit 35b, the driving signal output unit 35c outputs driving signals from the driving signal generating unit 35a to the respective inverter circuits 16, during the ON period of the determined duty cycle.

In the LUT 35d, a relationship between dimming instruction signals and optimum dimming frequencies in PWM dimming has been stored in advance. Specifically, in the LUT 35d, the luminance of the light-emitting surface instructed by a dimming instruction signal, and a value of dimming frequency at that luminance, at which sound waves from the respective cold-cathode fluorescent lamps 29 become the lowest, or, a noise level of the lighting device 28 becomes the lowest, are recognized and correlated in advance by conducting a test using an actual product of the lighting device 28, for example. Also, a dimming instruction signal is input into the LUT 35d, and the LUT 35d is connected to the dimming frequency obtaining unit 35b2. In this manner, in the lighting control unit 35, when a dimming instruction signal is input into the LUT 35d, a dimming frequency corresponding to the dimming instruction signal is immediately transmitted to the dimming frequency obtaining unit 35b2, and is reflected in the dimming signal generated in the dimming signal generating unit 35b.

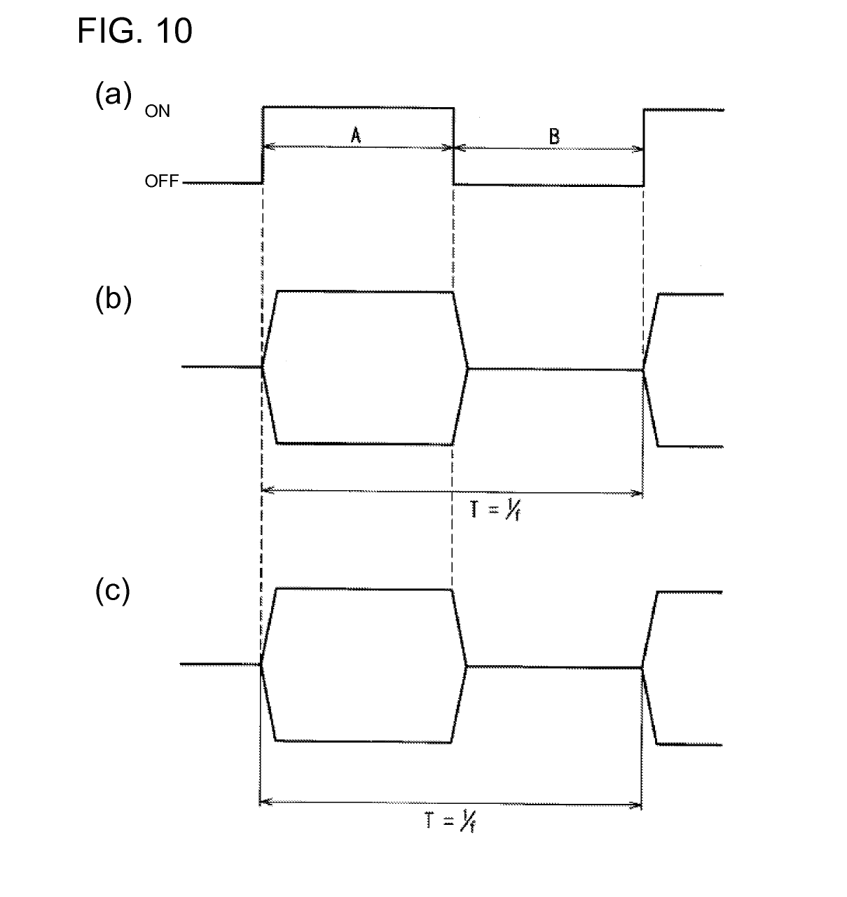

Referring to FIG. 10, operations of the liquid crystal display device 22 according to this embodiment configured in a manner described above will be specifically explained. In the explanation below, the lighting operation of the cold-cathode fluorescent lamps 29 in the lighting device 28 is mainly explained.

FIG. 10(a) is a waveform diagram illustrating a specific dimming signal generated in the dimming signal generating unit shown in FIG. 9. FIGS. 10(b) and 10(c) are waveform diagrams illustrating specific current waveforms supplied to cold-cathode fluorescent lamps from the inverter circuits.

In the lighting control unit 35 of the lighting device 28, when a dimming instruction signal is input from the outside, the dimming signal generating unit 35b generates a dimming signal exemplified in FIG. 10(a) based on the input dimming instruction signal. That is, in the dimming signal generating unit 35b, the duty cycle determining unit 35b1 determines ON time A and OFF time B in PWM dimming based on the input dimming instruction signal. Also, the dimming frequency obtaining unit 35b2 obtains a dimming frequency f corresponding to the input dimming instruction signal (i.e. an inverse number of a period T in PWM dimming) from the LUT 35d. Then, the dimming signal generating unit 35b generates and outputs the dimming signal to the driving signal output unit 35c.

After that, the driving signal output unit 35c outputs the driving signal from the driving signal generating unit 35a to the respective plurality of inverter circuits 16 according to the input dimming signal during the above-mentioned ON period A. Electric current is thereby supplied to all of the cold-cathode fluorescent lamps 29. FIGS. 10(b) and 10(c) respectively show electric current supplied to the cold-cathode fluorescent lamps 29a and 29b, for example. In this manner, the cold-cathode fluorescent lamps 29a and 29b perform the same lighting operations.

With the configuration described above, the features and effects similar to those in Embodiment 1 above can be achieved in this embodiment. Also, the plurality of cold-cathode fluorescent lamps 29 are provided in this embodiment. Therefore, the lighting device 28 with suppressed noise and high luminance can be configured with ease.

Although the explanations above have described cases in which all of the cold-cathode fluorescent lamps 29 were changed to the same dimming frequency according to a dimming instruction signal, this embodiment is not limited to such, and two adjacent cold-cathode fluorescent lamps 29 may be configured to be changed to different dimming frequencies from each other, when a dimming instruction signal is input, for example.

### Embodiment 3

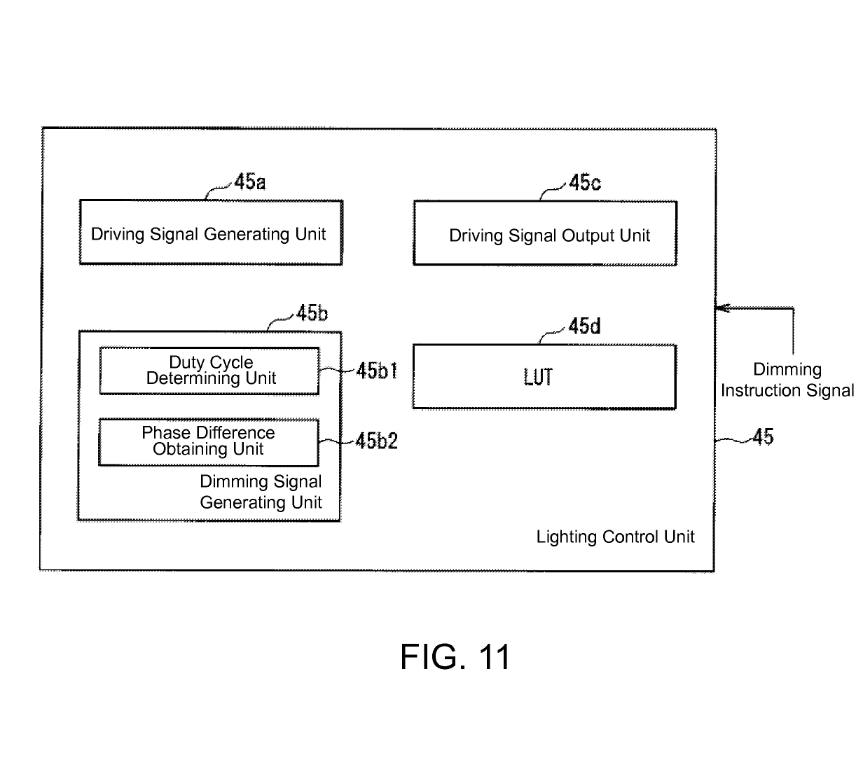

FIG. 11 is a block diagram illustrating a specific configuration of a lighting control unit of a lighting device according to Embodiment 3 of the present invention. In the figure, this embodiment differs from Embodiment 2 above mainly in that in an LUT, a relationship between dimming instruction signals and phase differences for a plurality of cold-cathode fluorescent lamps, instead of dimming frequencies, has been stored in advance, and that, when a dimming instruction signal is input, a lighting control unit obtains a phase difference that corresponds to the input dimming instruction signal from the LUT, and conducts driving control of inverter circuits such that the plurality of cold-cathode fluorescent lamps are driven and turned on by the obtained phase difference. The same reference characters are given to the same elements as those in Embodiment 2 above, and the overlapping explanations will be omitted.

That is, as shown in FIG. 11, a lighting control unit 45 according to this embodiment includes a driving signal generating unit 45a, a dimming signal generating unit 45b, a driving signal output unit 45c, and an LUT (look-up table) 45d as a storage unit, and generates and outputs driving signals to the inverter circuits 16 connected to the cold-cathode fluorescent lamps 29 based on the above-mentioned dimming instruction signal from the outside. Also, in the lighting control unit 45, ICs, LSI circuits, and the like, for example, are used for the respective units of the driving signal generating unit 45a, the dimming signal generating unit 45b, and the driving signal output unit 45c. The lighting control unit 45 is configured to turn on the respective plurality of cold-cathode fluorescent lamps 29 with inverters by determining a duty cycle in PWM dimming and the phase difference between the plurality of cold-cathode fluorescent lamps 29, such as two adjacent cold-cathode fluorescent lamps 29, for example, and by generating the above-mentioned driving signals based on the dimming instruction signal from the outside.

Specifically, in the lighting control unit 45, the driving signal generating unit 45a, which is for generating driving signals to drive the cold-cathode fluorescent lamps (light sources) 29, generates and outputs prescribed driving signals that are in a range of about 30 to 60 KHz to the driving signal output unit 45c, as described above. A clock signal generating unit, such as an IC or an LSI circuit, included in the lighting control unit 45 can be used for the driving signal generating unit 45a.

The dimming signal generating unit 45b has a duty cycle determining unit 45b1 and a phase difference obtaining unit 45b2 disposed therein. The duty cycle determining unit 45b1 determines a duty cycle of the ON period and the OFF period in the PWM cycle in PWM dimming, with which the cold-cathode fluorescent lamps 29 are driven and turned on, using a dimming instruction signal (instruction signal) from the outside. The phase difference obtaining unit 45b2 obtains, from the LUT 45d, dimming frequency that corresponds to the dimming instruction signal from the outside, and thereby selects the prescribed phase difference between two adjacent cold-cathode fluorescent lamps 29 that corresponds to the dimming instruction signal as instructed at that time. Then, based on the determined duty cycle and the selected phase difference, the dimming signal generating unit 45b generates and outputs a dimming signal to the driving signal output unit 45c.

According to the dimming signal from the dimming signal generating unit 45b, the driving signal output unit 45c outputs driving signals from the driving signal generating unit 45a to the respective inverter circuits 16 during the ON period of the determined duty cycle.

In the LUT 45d, a relationship between dimming instruction signals and optimum phase differences between two adjacent cold-cathode fluorescent lamps 29 has been stored in advance. Specifically, in the LUT 45d, the luminance of the light-emitting surface instructed by the dimming instruction signal, and a value of the phase difference at that luminance, at which sound waves from the respective cold-cathode fluorescent lamps 29 become the lowest, or a noise level of the lighting device 28 becomes the lowest, are recognized and correlated in advance by conducting a test using an actual product of the lighting device 28, for example. Also, a dimming instruction signal is input into the LUT 45d, and the LUT 45d is connected to the phase difference obtaining unit 45b2. In this manner, in the lighting control unit 45, when a dimming instruction signal is input into the LUT 45d, a phase difference corresponding to the dimming instruction signal is immediately transmitted to the phase difference obtaining unit 45b2, and is reflected in the dimming signal generated in the dimming signal generating unit 45b.

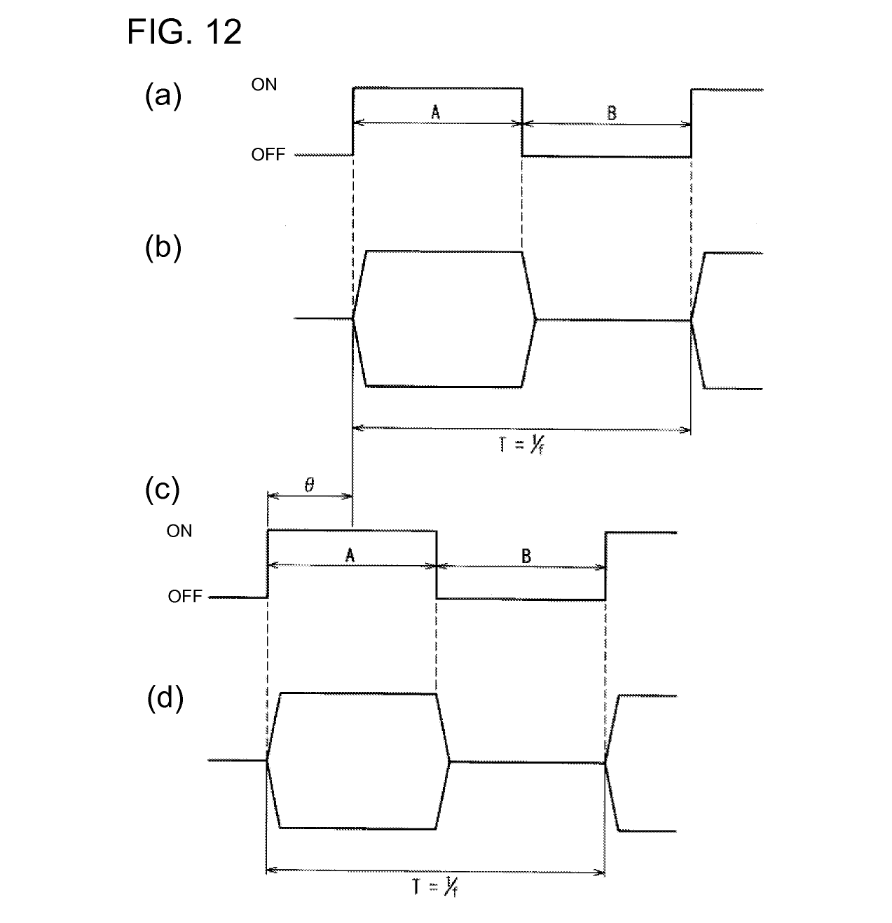

Here, referring to FIG. 12, operations of the liquid crystal display device 22 according to this embodiment configured in a manner described above will be specifically explained. In the explanations below, the lighting operation of the cold-cathode fluorescent lamps 29 in the lighting device 28 is mainly explained.

FIGS. 12(a) and 12(c) are waveform diagrams illustrating specific dimming signals generated in the dimming signal generating unit shown in FIG. 11. FIGS. 12(b) and 12(d) are waveform diagrams illustrating specific current waveforms supplied to cold-cathode fluorescent lamps from the above-mentioned inverter circuits.

In the lighting control unit 45 of the lighting device 28, when a dimming instruction signal is input from the outside, the dimming signal generating unit 45b generates a dimming signal exemplified in FIG. 12(a) based on the input dimming instruction signal. That is, in the dimming signal generating unit 45b, the duty cycle determining unit 45b1 determines ON time A and OFF time B in PWM dimming based on the input dimming instruction signal. Also, the phase difference obtaining unit 45b2 obtains a phase difference θ corresponding to the input dimming instruction signal from the LUT 45d. Then, the dimming signal generating unit 45b generates and outputs the dimming signal exemplified in FIG. 12(c) to the driving signal output unit 45c.

After that, the driving signal output unit 45c outputs driving signals from the driving signal generating unit 45a to the respective plurality of inverter circuits 16 according to the input dimming signal during the above-mentioned ON period A. Electric current is thereby supplied, with the phase difference θ, to the two adjacent cold-cathode fluorescent lamps 29: the cold-cathode fluorescent lamps 29a and 29b, for example, as shown in FIGS. 12(b) and 12(d), respectively. Therefore, such cold-cathode fluorescent lamps 29a and 29b perform the lighting operations with a phase shift of the above-mentioned phase difference θ.

With the configuration described above, the features and effects similar to those in Embodiment 2 above can be achieved in this embodiment.

The explanations above have described a configuration of changing the phase difference θ for every two adjacent cold-cathode fluorescent lamps 29. But in this embodiment, it is sufficient if a plurality of respective cold-cathode fluorescent lamps 29 can be driven and turned on with a phase shift based on a phase difference stored in the LUT (storage unit) 45d in advance. Specifically, when two adjacent cold-cathode fluorescent lamps 29 make one pair, for example, the respective pairs of the two cold-cathode fluorescent lamps 29 may be driven and turned on with different phase differences.

Also, other than the explanations above, a configuration of combining with Embodiment 2 is also possible. That is, it is possible to have a configuration in which an LUT (storage unit) having a relationship between dimming instruction signals and dimming frequencies in PWM dimming and a relationship between dimming instruction signals and phase differences for a plurality of cold-cathode fluorescent lamps (light sources) stored in advance, and when the dimming instruction signal is input, a lighting control unit (control unit) obtains, from the LUT, a dimming frequency and a phase difference that correspond to the input dimming instruction signal, and drives and controls inverter circuits (driver circuits) such that the plurality of cold-cathode fluorescent lamps are driven and turned on by the obtained dimming frequency and the obtained phase difference.

All of the embodiments above are illustrative and not restrictive. The technical scope of the present invention is defined by the claims, and all changes which come within the range of equivalency of the claims are therefore intended to be embraced therein.

In the explanations above, for example, cases in which the present invention is used for a transmissive liquid crystal display device have been described. But a lighting device of the present invention is not limited to such, and the present invention can be used for various display devices including a non-light emitting display unit that displays information, such as characters and images, utilizing light from a light source. Specifically, a lighting device of the present invention can be suitably used for a semi-transmissive liquid crystal display device or a projection display device that uses a liquid crystal panel as a light bulb.

Also, other than the explanations above, the present invention can be suitably used for an x-ray film viewer that irradiates an x-ray film with light, a light box that irradiates a photograph negative and the like with light to make them easier to view, and a lighting device of a light-emitting device that illuminates signs or advertisement placed on the wall surfaces in train stations, and the like.

In the explanations above, cases in which a cold-cathode fluorescent lamp is used as the light source have been described. But the light source of the present invention is not limited to such, and other electric discharge tubes, such as a hot-cathode fluorescent lamp or a xenon fluorescent lamp, non-straight tube type electric discharge tubes, such as a U-shaped tube or a pseudo-U-shaped tube, or light sources other than electric discharge tubes, such as a light-emitting diode can be used.

However, as described in each of the above embodiments, it is more preferable to use an electric discharge tube as a light source because a lighting device with a high luminance can be configured at a lower cost.

Also, in the explanations above, configurations in which an inverter circuit (driver circuit) is disposed on one end side of a cold-cathode fluorescent lamp in the longitudinal direction, and electric current is supplied to the cold-cathode fluorescent lamp from the one end side have been described, but the present invention is not limited to such, and a configuration in which inverter circuits are disposed on one end side and the other end side of a cold-cathode fluorescent lamp in the longitudinal direction, respectively, and electric current is supplied to the cold-cathode fluorescent lamp from both of one end side and the other end side is also possible.

Additionally, in the explanations above, configurations in which an LUT (look-up table) is used as the storage unit have been described. But the storage unit of the present invention is not limited to such, and a memory, such as EEPROM, an HDD, or the like can be used as the storage unit, for example.

However, as described in each of the above embodiments, it is more preferable to use an LUT as the storage unit because the lighting control unit (control unit) can obtain a dimming frequency and/or a phase difference more quickly, and can perform the instruction process to the inverter circuit (driver circuit) more rapidly.

### INDUSTRIAL APPLICABILITY

The present invention is useful for a lighting device that can suppress the generation of noise even when a light source is driven and turned on using PWM dimming, and for a display device using such a lighting device.

### DESCRIPTION OF REFERENCE CHARACTERS

1, 22 liquid crystal display devices (display devices)
3, 28 lighting devices
9, 29 (29a-29h) cold-cathode fluorescent lamps (light sources, electric discharge tubes)
10 light guide plate
10c light-emitting surface
15, 35, 45 lighting control units (control units)
15d, 35d, 45d LUTs (look-up tables, storage units)
16 inverter circuit (driver circuit)
30 diffusion plate
30a light-emitting surface

1: A lighting device, comprising;
a light source;
a light-emitting surface that emits light from the light source;
a driver circuit that drives and turns on the light source using PWM dimming;
a control unit that receives a dimming instruction signal that provides an instruction on a luminance of the light-emitting surface input from outside, and conducts driving control of the driver circuit based on the input dimming instruction signal; and
a storage unit storing in advance a relationship between dimming instruction signals and dimming frequencies in the PWM dimming,
wherein when a dimming instruction signal is input, the control unit obtains a dimming frequency that corresponds to the input dimming instruction signal from the storage unit, and conducts driving control of the driver circuit such that the light source is driven and turned on by the obtained dimming frequency.

2: A lighting device, comprising:
a plurality of light sources;
a light-emitting surface that emits light from the plurality of light sources;
driver circuits that drive and turn on the respective plurality of light sources using PWM dimming;
a control unit that receives a dimming instruction signal that provides instructions on a luminance of the light-emitting surface input from outside, and conducts driving control of the driver circuit based on the input dimming instruction signal; and
a storage unit storing in advance at least one of a relationship between dimming instruction signals and dimming frequencies in the PWM dimming and a relationship between the dimming instruction signals and phase differences for the plurality of light sources,
wherein when a dimming instruction signal is input, the control unit obtains, from the storage unit, at least one of a dimming frequency and a phase difference that correspond to the input dimming instruction signal, and conducts driving control of the driver circuit such that the plurality of light sources are driven and turned on by at least one of the obtained dimming frequency and the obtained phase difference.

3: The lighting device according to claim 1, comprising a look-up table as the storage unit.

4: The lighting device according to claim 1, comprising an electric discharge tube as the light source.

5: A display device comprising the lighting device according to claim 1.
